(19) United States
(12) Patent Application Publication
(10) Pub. No.: US 2004/0008185 A1
(43) Pub. Date: Jan. 15, 2004

(54) Data processing device, presentation device, and projection method for presentation

(75) Inventor: Shih-Jung Tsai, Taipei (TW)

Correspondence Address: QUINTERO LAW OFFICE, 1617 BROADWAY, 3RD FLOOR, SANTA MONICA, CA, 90404, US

(73) Assignee: Mitac International Corp.

(21) Appl. No.: 10/401,228

(22) Filed: Mar. 27, 2003

(30) Foreign Application Priority Data
Mar. 29, 2002 (TW) 91106410

(51) Int. Cl. G09G 5/08

(52) U.S. Cl. 345/157

(57) ABSTRACT

A presentation device. The presentation device includes a display panel, a touch panel, and an image projector. The display panel having a display region displays presentation data. The touch panel obtains a coordinate from touch screen input. The image projector projects an indicating point according to the coordinates of the input region and the presentation data to a corresponding region on a screen.

### BACKGROUND OF THE INVENTION

1. Field of the Invention

The present invention relates to a data processing device, a presentation device, and a projection method for presentation, and more particularly to a data processing device, presentation device, and projection method for simulating laser effect by a touch panel.

2. Description of the Related Art

In conventional presentation, a presenter has to operate an overhead projector, a slide projector, or a film projector to display the report.

With the development of multimedia technology, one can edit pictures, voice, animation, or movie by a multimedia computer. In addition, the presentation can be edited by the multimedia computer and displayed by a projector. FIG. 1 shows the conventional multimedia presentation system. The conventional system comprises a data processing device 10 and an image projector 12. The multimedia data generated by the multimedia computer is displayed on a monitor 11 and projected onto a screen 13 through a projector 12. A presenter 14 thus gives the presentation according to data displayed on the monitor 11 or the screen 13.

During the presentation, the presenter 14 usually uses an indicator pointing device 16 to project an indicator point 15 on the screen 13 to point out a predetermined region to help audience members understand the presentation. Thus, the effect of the presentation and the interaction between the presenter 14 and the audience members is improved.

Therefore, the indicator pointing device is important for the presenter 14 during the presentation. However, it is inconvenient for the presenter 14 to carry an indicator pointing device. Moreover, the effect of the presentation is degraded when the power of the indicator pointing device is low.

Recently, some data process devices have touch control function, such as personal digital assistants, which detects input and determines the input coordinate to provide more conventional control of the data devices.

### SUMMARY OF THE INVENTION

The object of the present invention is to provide a data processing device, presentation device, and projection method for presentation, which simulates the laser effect by a touch panel. In addition, the effect of the indicator pointing device is represented by software, Therefore, the presenter can explain the presentation without the indicator pointing device. Thus, the cost of the indicator pointing device is saved and the inconvenience of a separate indicator pointing device is avoided.

To achieve the above-mentioned object, the present invention provides a data processing device including a touch panel and a display panel. The touch panel obtains a coordinate from touch screen input. The display panel having a display region displays predetermined data and an indicating point on the display region according to the coordinates of the input region.

Moreover, the present invention provides a presentation device including a display panel, a touch panel, and an image projector. The display panel having a display region displays presentation data. The touch panel obtains a coordinate from touch screen input. The image projector projects an indicating point according to the coordinates of the input region and the presentation data to a corresponding region on a screen.

Moreover, the present provides a projection method of a presentation using a display panel and a touch panel. First, presentation data shown on the display panel is projected onto a screen. Next, a coordinate detected by the touch panel is obtained. Finally, an indicating point according to the coordinates of the input region is displayed.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows the conventional multimedia presentation system.

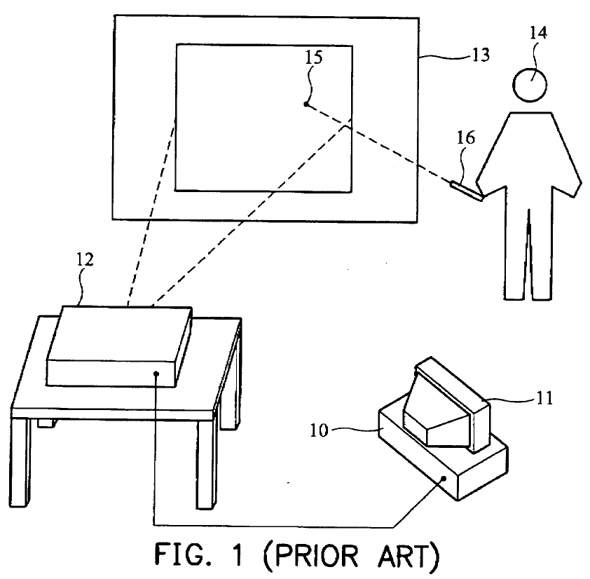

FIG. 2 shows the multimedia presentation system according to the embodiment of the present invention.

FIG. 3 shows the data processing device according to the embodiment of the present invention.

FIG. 4 shows the flow chart of the multimedia presentation system according to the embodiment of the present invention.

FIG. 5 shows the outward appearance of the multimedia presentation system according to the embodiment of the present invention.

### DETAILED DESCRIPTION OF THE INVENTION

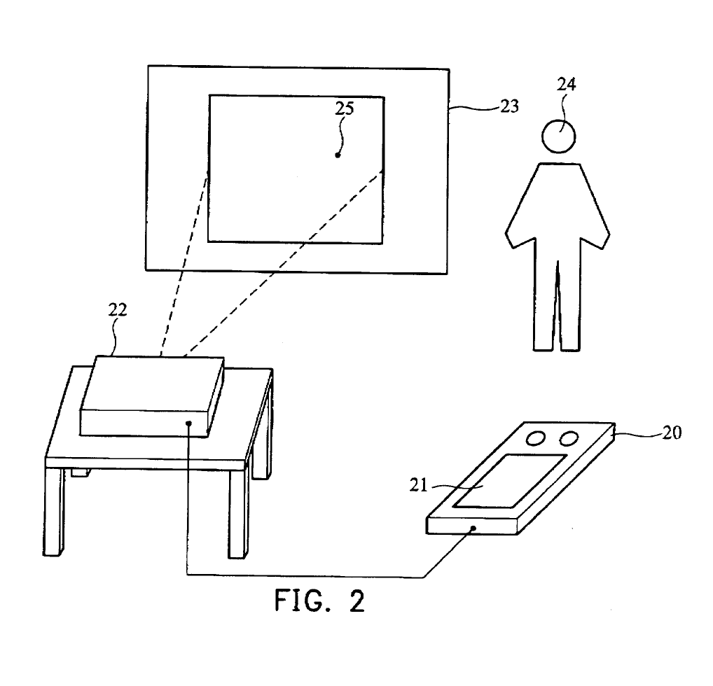

FIG. 2 shows the multimedia presentation system according to the embodiment of the present invention. The multimedia presentation system according to the embodiment of the present invention comprises a data processing device 20 and an image projector 22. The multimedia data generated by the multimedia computer is displayed on a display region 21 on the display panel and projected onto a screen 23 through a projector 22. Therefore, a presenter 24 reports the presentation according to data displayed on the screen 23.

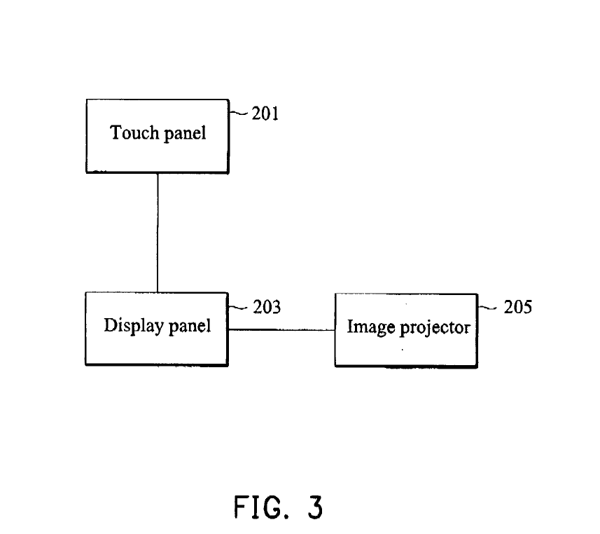

FIG. 3 shows the data processing device according to the embodiment of the present invention. In the embodiment, the data processing device can be a desktop computer, a notebook, or a personal digital assistant (PDA) for giving a presentation. The data processing device 20 according to the embodiment of the present invention comprises a touch panel 201 a display panel 203, and an image projector 205. The display panel 203 comprises a display region 21 to display the presentation data. Here, the display panel 203 is a liquid crystal display panel. The touch panel 201 detects the region input by the presenter 24 on the touch panel 201 and obtains the coordinates of the input region. The image projector 205 projects the presentation data and an indicator point 25 onto the screen 23, wherein the position of the indicator point 25 on the screen 23 corresponds to the input region on the display region 21.

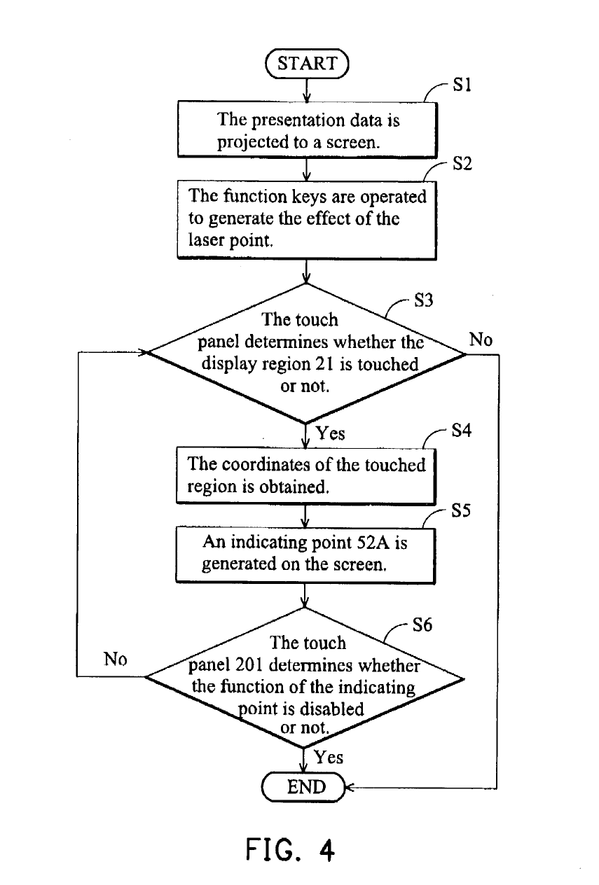

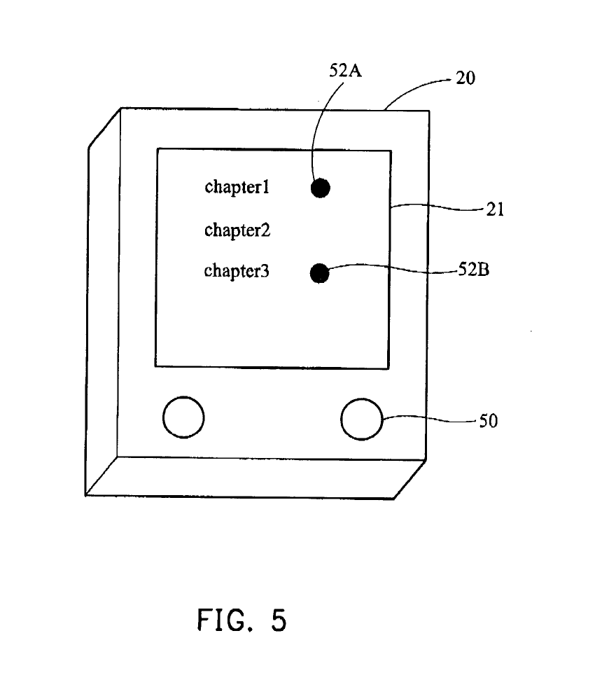

FIG. 4 shows the flow chart of the multimedia presentation system according to the embodiment of the present invention. FIG. 5 shows the outward appearance of the multimedia presentation system according to the embodiment of the present invention.

The operating flow of the multimedia presentation system according to the embodiment of the present invention is described below. In the beginning of a presentation, the data processing device 20 projects the presentation data shown on the display region 21 onto a screen 23 by the image projector 205 (S1). The operation of step S1 is similar to conventional means, and is omitted to simplify the specification. Next, the presenter 24 operates the function keys 50 using the effect of the indicator point (S2). Next, the presenter 24 selects a predetermined region by touching the display region 21 of the display panel 203, and the touch panel 201 detects the presence or absence of input therefrom (S3). If present, the touch panel 201 obtains the coordinates of the input region (S4). An indicating point 52A is generated on the screen 23 to indicate a specific data, wherein the position of the indicating point 52A on the screen 23 corresponds to the input region on the display region 21 (S5). Next, the touch panel 201 determines whether the function of the indicating point is disabled or not (S6). If not, steps S3-S5 are repeated. For example, if the presenter 23 touches another region on the display region 21, another indicating point 52B is generated on the screen 23 according to the coordinate of the present input region detected by the touch panel 201. If so, the function of the indicating point is terminated. Thus, the effect of the indicator point is simulated without using an indicator pointing device.

Accordingly, the present invention provides a data processing device, a presentation device, and a projection method for presentation, which simulates the laser effect by a touch panel. In addition, the presenter can give the presentation without a separate indicator pointing device. Thus, the cost of the indicator pointing device is saved and the inconvenience of a separate indicator pointing device is avoided,

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A data processing device, comprising:
a touch panel for obtaining a coordinate from touch screen input; and
a display panel having a display region for displaying a predetermined data and an indicating point on the display region according to the coordinates of the input region.

2. The data processing device as claimed in claim 1, wherein the display panel is a liquid crystal display panel.

3. The data processing device as claimed in claim 1, further comprising a function key for enabling function of the indicating point.

4. A presentation device, comprising:
a display panel having a display region for displaying presentation data;
a touch panel for obtaining a coordinate from touch screen input; and
an image projector for projecting an indicating point according to the coordinates of the input region and the presentation data to a corresponding region on a screen.

5. The presentation device as claimed in claim 4, wherein the display panel is a liquid crystal display panel.

6. The presentation device as claimed in claim 4, further comprising a function key for enabling function of the indicating point.

7. A projection method of a presentation using a display panel and a touch panel, the method comprising the following steps:
projecting presentation data shown on the display panel onto a screen;
obtaining a coordinate of an input region detected by the touch panel; and
displaying an indicating point according to the coordinates of the input region.
